(19) United States
(12) Patent Application Publication
(10) Pub. No.: US 2010/0103399 A1
(43) Pub. Date: Apr. 29, 2010

(54) Fluid Assisted Gas Gauge Proximity Sensor

(75) Inventors: Joseph H. LYONS, Wilton, CT (US); Geoffrey Alan SCHULTZ, Shelton, CT (US)

Correspondence Address: STERNE, KESSLER, GOLDSTEIN & FOX P.L.L.C., 1100 NEW YORK AVENUE, N.W., WASHINGTON, DC, 20005, US

(73) Assignee: ASML Holding N.V., Veldhoven (NL)

(21) Appl. No.: 12/547,739

(22) Filed: Aug. 26, 2009

Related U.S. Application Data
(60) Provisional application No. 61/107,880, filed on Oct. 23, 2008.

(51) Int. Cl. G03B 27/72; G01L 13/02

(52) U.S. Cl. 355/71; 73/716

(57) ABSTRACT

A fluid assisted gas gauge coupled to a pressure sensor enables proximity measurements to be made with a high bandwidth. A two-chamber gas gauge, containing a gas-filled measurement chamber and a fluid-filled transfer chamber and a diaphragm separating the two chambers, exhausts gas onto the surface being measured, while the incompressible fluid transmits the pressure to a pressure sensor. By minimizing the gas volume of the gas gauge, the response time is enhanced. In addition, the incompressible fluid permits the pressure sensor to be remotely located from the point of measurement without sacrificing the response time performance. In an embodiment, a differential bridge version of the fluid assisted gas gauge reduces common mode effects.

### CROSS REFERENCE TO RELATED APPLICATION(S)

This application claims benefit under 35 U.S.C. §119(e) to U.S. Provisional Patent Application No. 61/107,880, filed Oct. 23, 2008, which is incorporated by reference herein in its entirety.

### BACKGROUND

1. Field of the Invention

The present invention relates to a proximity sensor, and in particular to a proximity sensor for use in semiconductor lithographic applications.

2. Related Art

Many automated manufacturing processes require the sensing of the distance between a manufacturing tool and the product or material surface being worked upon. In some situations, such as semiconductor lithography, that distance must be measured with an accuracy approaching a nanometer.

The challenges associated with creating a proximity sensor of such accuracy are significant, particularly in the context of photolithography systems. In the photolithography context, in addition to the needs to be non-intrusive and to precisely detect very small distances, the proximity sensor cannot introduce contaminants or come in contact with the work surface, typically a semiconductor wafer. Occurrence of either situation may significantly degrade or ruin the quality of the material surface or product being worked upon.

Different types of proximity sensors are available to measure very small distances. Examples of proximity sensors include capacitance gauges and optical gauges. These proximity sensors have serious shortcomings when used in lithographic projection systems because the physical properties of materials deposited on wafers may impact the precision of these sensors. For example, capacitance gauges, being dependent on the dielectric of intervening layers, can yield spurious proximity readings in locations where a mix of material (e.g., metal) is concentrated. More generally, optical and capacitive methods are prone to errors due to significant interactions with layers beneath photoresist coatings. Another class of problem occurs when exotic wafers made of non-conductive and/or photosensitive materials, such as Gallium Arsenide (GaAs) and Indium Phosphide (InP), are used. In these cases, capacitance gauges and optical gauges may provide spurious results, and are therefore not optimal.

A typical gas gauge pressure sensor contains a reference nozzle and one or more measurement nozzles to emit a gas flow onto reference and measurement surfaces. Measurements are made of the back pressure differences within the sensors to determine the distance between the measurement nozzle and the measurement surface. A gas gauge pressure sensor is not vulnerable to concentrations of electric charges or to the electrical, optical or other physical properties of a wafer surface. A gas gauge pressure sensor detects only the top physical layer, and thereby yields a superior result. Accordingly, these types of gauges are ideal for topographic measurement of a material surface, such as that used to establish focus prior to lithographic exposure.

Speed of measurement is a critical performance driver in current semiconductor manufacturing processes. Specifically, proximity sensors with high bandwidth are necessary to support current semiconductor manufacturing throughput practice. However, gas gauge proximity sensors are limited in their response time by virtue of their internal cavity volumes. Internal cavity volumes impose a finite time constant that limits the ability to shorten their available response time. Although the time constant may be lessened by reducing the size of the internal cavity volume, there are practical limitations as to how small the internal cavity volume can become. For example, the pressure sensing component of the proximity sensor often cannot be placed physically close to the nozzle of the proximity sensor. Moreover, sensitivity requirements often dictate the need for large sensor sizes. Further, the need for low pressures, such as those employed in extreme ultraviolet (EUV) based lithographic tools, exacerbates further the response time challenge. Thus despite the benefits of these gas gauge types of proximity sensors, the specter of a severely limited bandwidth remains a crucial obstacle to the use of air gauge proximity sensors.

### SUMMARY

Therefore, what is needed is an apparatus and method to provide a gas gauge proximity sensor that delivers a suitable frequency response at useful low pressures, with useful sensitivity, and to facilitate remote sensing of the chamber pressure.

In one embodiment of the present invention, a proximity sensor is provided that couples a pressure sensor to a fluid assisted gas gauge to enable proximity measurements to be made at a high bandwidth. The proximity sensor contains a measurement chamber and a transfer chamber, with a diaphragm separating the two chambers. The measurement chamber contains a gas, while the transfer chamber contains an incompressible fluid that is connected via a fluid transmission line to the pressure sensor. The gas in the measurement chamber is supplied by a gas source via an input port that may optionally include a restrictor. The gas exhausts via the exit aperture that is located close to the surface of the substrate being measured. The proximity of the surface of the substrate to the exit aperture affects the gas flow restriction, and thereby the pressure in the measurement chamber. By communicating that pressure in the measurement chamber to the transfer chamber via movement of the diaphragm, and in turn communicating the pressure in the transfer chamber to the pressure sensor via the fluid transmission line, the topology of the substrate surface can be determined by monitoring the output of the pressure sensor. By using incompressible fluid to communicate the pressure in the measurement chamber, the volume of the measurement chamber can be minimized with the result that the response time (i.e., speed) of the proximity sensor is substantially increased.

In various embodiments of the present invention, different gases and incompressible fluids can be used. Further, the exit aperture of the measurement chamber can be shaped in order to tailor the resulting gas flow conditions. For example, different aperture shapes and sizes can be used. In addition, the shape of the measurement chamber and the transfer chambers can be any shape commensurate with the need to fulfill the functions described for them. A typical shape for these chambers can be cylindrical.

In a further embodiment of the present invention, different pressure sensors can be used. For example, a diaphragm-based sensor can be used. Within this type of pressure sensor, sensing of the deflection of the diaphragm can be accomplished by different means including optical, inductive, piezoresistive and capacitive sensing. Alternatively, the pressure sensor could be a non-diaphragm based pressure sensor, e.g., a restricted mass flow sensor.

In a further embodiment of the present invention, a bridge version of the proximity sensor can be used. In this embodiment, two arms, a measurement arm and a reference arm, are used to provide a differential pressure measurement. Both arms have a measurement chamber and a transfer chamber, but the reference arm is provided with a reference standoff that is set a prescribed distance from the exit aperture of the reference measurement chamber. Both the measurement arm and the reference arm are supplied with gas from the same gas source. In this embodiment, the difference in pressure readings found in the measurement and reference arms is used to determine the separation (and therefore the topography) of the surface of the substrate from the proximity sensor. The bridge embodiment offers the advantage that any common mode errors (such as pressure variations within the gas source) are eliminated since they affect both sides of the bridge and are thereby cancelled in the differential measurement.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIGS. 1A and 1B respectively depict reflective and transmissive lithographic apparatuses.

FIG. 2 is a diagram of a gas gauge proximity sensor, according to an embodiment of the present invention.

FIG. 3 provides a flowchart of a method that uses an incompressible fluid subsystem to transmit the measurement chamber pressure across an arbitrary distance to a pressure sensor, according to an embodiment of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

This specification discloses one or more embodiments that incorporate the features of this invention. The disclosed embodiment(s) merely exemplify the invention. The scope of the invention is not limited to the disclosed embodiment(s). The invention is defined by the claims appended hereto.

The embodiment(s) described, and references in the specification to “one embodiment”, “an embodiment”, “an example embodiment”, etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

Before describing such embodiments in more detail, however, it is instructive to present an example environment in which embodiments of the present invention may be implemented.

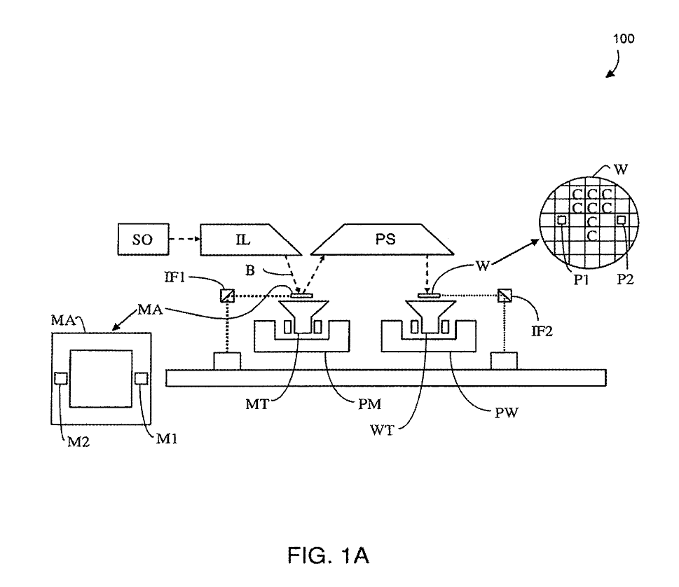

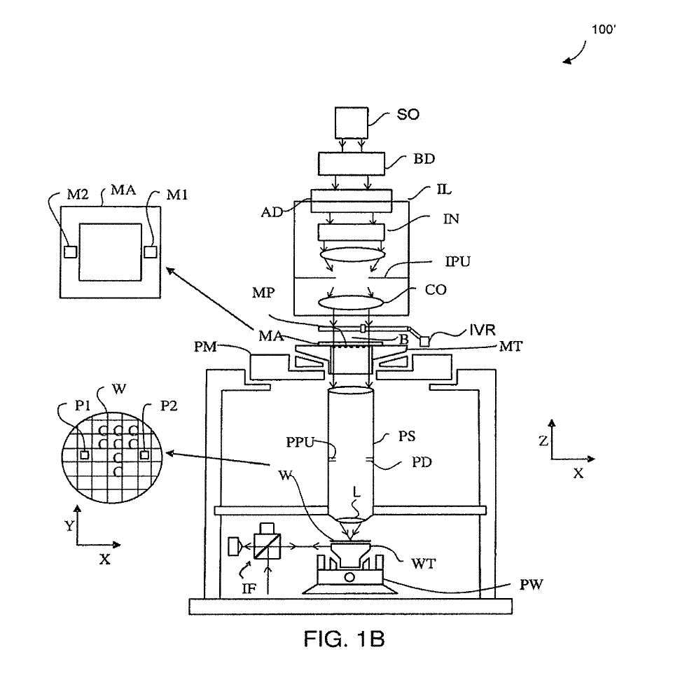

FIGS. 1A and 1B schematically depict lithographic apparatus 100 and lithographic apparatus 100′, respectively. Lithographic apparatus 100 and lithographic apparatus 100′ each include: an illumination system (illuminator) IL configured to condition a radiation beam B (e.g., DUV or EUV radiation); a support structure (e.g., a mask table) MT configured to support a patterning device (e.g., a mask, a reticle, or a dynamic patterning device) MA and connected to a first positioner PM configured to accurately position the patterning device MA; and a substrate table (e.g., a wafer table) WT configured to hold a substrate (e.g., a resist coated wafer) W and connected to a second positioner PW configured to accurately position the substrate W. Lithographic apparatuses 100 and 100′ also have a projection system PS configured to project a pattern imparted to the radiation beam B by patterning device MA onto a target portion (e.g., comprising one or more dies) C of the substrate W. In lithographic apparatus 100 the patterning device MA and the projection system PS is reflective, and in lithographic apparatus 100′ the patterning device MA and the projection system PS is transmissive.

The illumination system IL may include various types of optical components, such as refractive, reflective, magnetic, electromagnetic, electrostatic or other types of optical components, or any combination thereof, for directing, shaping, or controlling the radiation B.

The support structure MT holds the patterning device MA in a manner that depends on the orientation of the patterning device MA, the design of the lithographic apparatuses 100 and 100′, and other conditions, such as for example whether or not the patterning device MA is held in a vacuum environment. The support structure MT may use mechanical, vacuum, electrostatic or other clamping techniques to hold the patterning device MA. The support structure MT may be a frame or a table, for example, which may be fixed or movable, as required. The support structure MT may ensure that the patterning device is at a desired position, for example with respect to the projection system PS.

The term “patterning device” MA should be broadly interpreted as referring to any device that may be used to impart a radiation beam B with a pattern in its cross-section, such as to create a pattern in the target portion C of the substrate W. The pattern imparted to the radiation beam B may correspond to a particular functional layer in a device being created in the target portion C, such as an integrated circuit.

The patterning device MA may be transmissive (as in lithographic apparatus 100′ of FIG. 1B) or reflective (as in lithographic apparatus 100 of FIG. 1A). Examples of patterning devices MA include reticles, masks, programmable mirror arrays, and programmable LCD panels. Masks are well known in lithography, and include mask types such as binary, alternating phase shift, and attenuated phase shift, as well as various hybrid mask types. An example of a programmable mirror array employs a matrix arrangement of small mirrors, each of which may be individually tilted so as to reflect an incoming radiation beam in different directions. The tilted mirrors impart a pattern in the radiation beam B which is reflected by the mirror matrix.

The term “projection system” PS may encompass any type of projection system, including refractive, reflective, catadioptric, magnetic, electromagnetic and electrostatic optical systems, or any combination thereof, as appropriate for the exposure radiation being used, or for other factors, such as the use of an immersion liquid or the use of a vacuum. A vacuum environment may be used for EUV or electron beam radiation since other gases may absorb too much radiation or electrons. A vacuum environment may therefore be provided to the whole beam path with the aid of a vacuum wall and vacuum pumps.

Lithographic apparatus 100 and/or lithographic apparatus 100′ may be of a type having two (dual stage) or more substrate tables (and/or two or more mask tables) WT. In such “multiple stage” machines the additional substrate tables WT may be used in parallel, or preparatory steps may be carried out on one or more tables while one or more other substrate tables WT are being used for exposure. When the preparatory steps can be performed while one or more other substrate tables WT are being used for exposure, the preparatory steps are said to occur during an “in-line phase” because the preparatory steps are performed within the desired throughput of the lithographic apparatus 100 and/or lithographic apparatus 100′. In contrast, when the preparatory steps cannot be performed while one or more other substrate tables WT are being used for exposure, the preparatory steps are said to occur during an “off-line phase” because the preparatory steps cannot be performed within a desired throughput of lithographic apparatus 100 and/or lithographic apparatus 100′. As described in more detail herein, focus-positioning parameters of an exposure system (such as, for example projection system PS of lithographic apparatuses 100, 100′) may be determined in an off-line phase, an in-line phase, or a combination thereof.

Referring to FIGS. 1A and 1B, the illuminator IL receives a radiation beam from a radiation source SO. The source SO and the lithographic apparatuses 100, 100′ may be separate entities, for example when the source SO is an excimer laser. In such cases, the source SO is not considered to form part of the lithographic apparatuses 100 or 100′, and the radiation beam B passes from the source SO to the illuminator IL with the aid of a beam delivery system BD (FIG. 1B) comprising, for example, suitable directing mirrors and/or a beam expander. In other cases, the source SO may be an integral part of the lithographic apparatuses 100, 100′—for example when the source SO is a mercury lamp. The source SO and the illuminator IL, together with the beam delivery system BD, if required, may be referred to as a radiation system.

The illuminator IL may comprise an adjuster AD (FIG. 1B) for adjusting the angular intensity distribution of the radiation beam. Generally, at least the outer and/or inner radial extent (commonly referred to as σ-outer and σ-inner, respectively) of the intensity distribution in a pupil plane of the illuminator may be adjusted. In addition, the illuminator IL may comprise various other components (FIG. 1B), such as an integrator IN and a condenser CO. The illuminator IL may be used to condition the radiation beam B, to have a desired uniformity and intensity distribution in its cross section.

Referring to FIG. 1A, the radiation beam B is incident on the patterning device (e.g., mask) MA, which is held on the support structure (e.g., mask table) MT, and is patterned by the patterning device MA. In lithographic apparatus 100, the radiation beam B is reflected from the patterning device (e.g., mask) MA. After being reflected from the patterning device (e.g., mask) MA, the radiation beam B passes through the projection system PS, which focuses the radiation beam B onto a target portion C of the substrate W. With the aid of the second positioner PW and position sensor IF2 (e.g., an interferometric device, linear encoder or capacitive sensor), the substrate table WT may be moved accurately, e.g. so as to position different target portions C in the path of the radiation beam B. Similarly, the first positioner PM and another position sensor IF1 may be used to accurately position the patterning device (e.g., mask) MA with respect to the path of the radiation beam B. Patterning device (e.g., mask) MA and substrate W may be aligned using mask alignment marks M1, M2 and substrate alignment marks P1, P2.

Referring to FIG. 1B, the radiation beam B is incident on the patterning device (e.g., mask MA), which is held on the support structure (e.g., mask table MT), and is patterned by the patterning device. Having traversed the mask MA, the radiation beam B passes through the projection system PS, which focuses the beam onto a target portion C of the substrate W. With the aid of the second positioner PW and position sensor IF (e.g., an interferometric device, linear encoder or capacitive sensor), the substrate table WT can be moved accurately, e.g. so as to position different target portions C in the path of the radiation beam B. Similarly, the first positioner PM and another position sensor (which is not explicitly depicted in FIG. 1B) can be used to accurately position the mask MA with respect to the path of the radiation beam B, e.g., after mechanical retrieval from a mask library, or during a scan.

In general, movement of the mask table MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the mask table MT may be connected to a short-stroke actuator only, or may be fixed. Mask MA and substrate W may be aligned using mask alignment marks M1, M2 and substrate alignment marks P1, P2. Although the substrate alignment marks as illustrated occupy dedicated target portions, they may be located in spaces between target portions (known as scribe-lane alignment marks). Similarly, in situations in which more than one die is provided on the mask MA, the mask alignment marks may be located between the dies.

The lithographic apparatuses 100 and 100′ may be used in at least one of the following modes.

In step mode, the support structure (e.g., mask table) MT and the substrate table WT are kept essentially stationary, while an entire pattern imparted to the radiation beam B is projected onto a target portion C at one time (i.e., a single static exposure). The substrate table WT is then shifted in the X and/or Y direction so that a different target portion C may be exposed.

In scan mode, the support structure (e.g., mask table) MT and the substrate table WT are scanned synchronously while a pattern imparted to the radiation beam B is projected onto a target portion C (i.e., a single dynamic exposure). The velocity and direction of the substrate table WT relative to the support structure (e.g., mask table) MT may be determined by the (de-)magnification and image reversal characteristics of the projection system PS.

In another mode, the support structure (e.g., mask table) MT is kept substantially stationary holding a programmable patterning device, and the substrate table WT is moved or scanned while a pattern imparted to the radiation beam B is projected onto a target portion C. A pulsed radiation source SO may be employed and the programmable patterning device is updated as required after each movement of the substrate table WT or in between successive radiation pulses during a scan. This mode of operation may be readily applied to maskless lithography that utilizes programmable patterning device, such as a programmable mirror array of a type as referred to herein.

Combinations and/or variations on the described modes of use or entirely different modes of use may also be employed.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion,” respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

The terms “radiation” and “beam” used herein encompass all types of electromagnetic radiation, including ultraviolet (UV) radiation (e.g., having a wavelength of or about 365, 248, 193, 157 or 126 nm) or extreme ultraviolet radiation (e.g., having a wavelength of 5 nm or above).

The term “lens,” where the context allows, may refer to any one or combination of various types of optical components, including refractive and reflective optical components.

U.S. patent application Ser. Nos. 11/646,612 and 10/322,768, and U.S. Pat. Nos. 4,953,388 and 4,550,592, all of which are incorporated herein by reference in their entireties, disclose exemplary alternative approaches to proximity sensing through the use of a gas gauge pressure sensor.

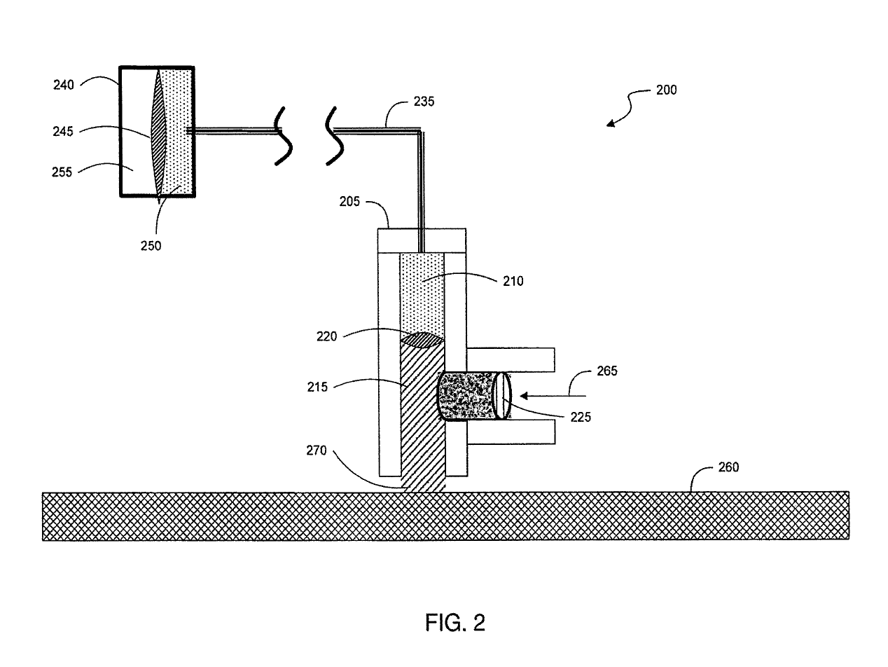

FIG. 2 provides a diagram of a proximity sensor 200, in accordance with an embodiment of the present invention. Proximity sensor 200 comprises a housing 205 that includes two internal chambers: a transfer chamber 210 and a measurement chamber 215. The transfer chamber 210 and the measurement chamber 215 are separated by a gas-fluid diaphragm 220. Transfer chamber 210 contains an incompressible fluid, while measurement chamber 215 contains a gas. Gas flowing out of the measurement chamber 215 impinges on the substrate 260, which is located a short distance away. The actual separation distance dictates the velocity of the gas flow, and thus the pressure within the measurement chamber 215, as is known for such gas pressure gauges.

Transfer chamber 210 is a closed chamber with the gas-fluid diaphragm 220 at a location (typically one end), and a connection to a fluid transmission line 235 at another location, typically the other end of the transfer chamber 210. Both the transfer chamber 210 and the fluid transmission line 235 contain an incompressible fluid. Pressure sensor 240 is coupled to the fluid transmission line 235. The transfer chamber 210, fluid transmission line 235 and pressure sensor 240 form a closed fluid subsystem, such that the pressure of the incompressible fluid in the transfer chamber 210 is transmitted to the pressure sensor 240 for measurement.

Still referring to FIG. 2, the gas-fluid diaphragm 220 is located at one location, typically one end, of the measurement chamber 215. As noted above, the measurement chamber 215 is filled with gas. As such, the gas-fluid diaphragm 220 provides a gas-fluid interface within the housing 205. At a second location separate from the location of the gas-fluid diaphragm 220, measurement chamber 215 is supplied with gas from a gas source (not shown in FIG. 2) via an input port 265. Optionally, an isolating restrictor 225 may be included in the input port 265 in order to stabilize the input pressure from the gas source. Such an isolating restrictor 225 serves to isolate the proximity sensor 200 from any pressure fluctuations in the gas source. At a third location within the measurement chamber 215 is an exit aperture 270 from which gas escapes from the measurement chamber 215, and ultimate impinges upon the surface of the substrate 260.

Continuing to refer to FIG. 2, a gas subsystem is formed by the gas source, the optional isolating restrictor 225, the input port 265, the measurement chamber 215 and the exit aperture 270. U.S. application Ser. Nos. 11/646,612 and 10/322,768 and U.S. Pat. Nos. 4,953,388 and 4,550,592, all of which are incorporated herein by reference in their entireties, disclose various aspects of proximity sensing through the use of exemplary gas gauge pressure sensors. As these applications and patents indicate, the exit aperture 270 can take the form of a nozzle. By supplying the measurement chamber 215 with gas under pressure, and permitting the gas to exit via the exit aperture 270 proximate to the substrate 260, a steady state gas flow condition arises. Such a gas flow condition permits the proximity of the exit aperture 270 to the surface of the substrate 260 to be imputed from a measurement of the pressure within measurement chamber 215, in accordance with the following principles.

Under steady state conditions, a simple relationship exists between the resulting pressure of the measurement chamber 215 and the distance between the exit aperture 270 and the nearby surface 260. If the distance between the exit aperture 270 and the nearby surface 260 is increased, the flow of gas increases since the impediment to gas flow has been diminished. Consequently, with increased gas flow, the measurement chamber 215 pressure decreases in accordance with Bernoulli's principle. Conversely, if the distance between the exit aperture 270 and the nearby surface 260 is decreased, the impediment to gas flow is increased, the gas flow thereby decreases, and the resulting pressure of the measurement chamber 215 increases. At one limit, if the exit aperture 270 is sealed off (as say by having the nearby surface completely obstructing the exit aperture 270), the resulting pressure is equal to the gas supply pressure.

The gas pressure in the measurement chamber 215 acts upon the gas-fluid diaphragm 220. By virtue of the flexible nature of the gas-fluid diaphragm 220, the gas-fluid diaphragm 220 deflects until the pressure on the fluid side of the gas-fluid diaphragm 220 equalizes to the pressure created on the gas side of the gas-fluid diaphragm 220. In turn, the pressure on the fluid side of the gas-fluid diaphragm 220 is transmitted through the fluid transmission line 235 to the pressure sensor 240. The pressure sensor 240 outputs a signal related to the pressure transmitted through the fluid transmission line 235. Thus, by measuring the pressure using the pressure sensor 240, the pressure internal to measurement chamber 215 can be remotely measured. Since the pressure internal to measurement chamber 215 is related to the proximity between the exit aperture 270 and the surface of the substrate 260, such a proximity can be remotely measured via the pressure sensor 240.

The above discussion deals with the static relationships between pressure at various locations, the flow rate at the exit aperture 270 and the separation between the exit aperture 270 and the surface of the substrate 260. However, as noted earlier, what is also critical to a modern day lithographic measurement apparatus is the speed of measurement. Speed of measurement is limited in part by the bandwidth of the measurement system. For the proximity sensor 200 described above, the size of gas volume is an important factor in determining its bandwidth. Steady state conditions require the transient behavior within the measurement chamber 215 until equilibrium is reached. The greater the dimensions (i.e., the larger the volume) of the measurement chamber 215, the longer it takes to reach equilibrium, and the larger the time constant of the measurement chamber 215. Conversely, the smaller the dimensions of the measurement chamber 215, the smaller the time constant and the greater the bandwidth of the proximity sensor 200.

By contrast, the incompressible nature of the fluid within the transfer chamber 210 and the fluid transmission line 235 results in a rapid transmission of the transients to reach steady state equilibrium. Consequently, the incompressible fluid subsystem propagates any transient behavior quickly from the gas-fluid diaphragm 220 through to the pressure sensor 240. Therefore, the pressure sensor 240 can be located remotely from the substrate surface being measured, and the response time (or bandwidth) of the proximity sensor 200 is not unduly compromised. Designers using this type of proximity sensor 200 will therefore seek to minimize the volume of the measurement chamber 215, while communicating with the remote pressure sensor 240 through an appropriate length of fluid transmission line 235. The fluid transmission line 235 can be constructed of any material consistent with the requirement to contain the incompressible fluid and make the appropriate connections to the transfer chamber 210 and the pressure sensor 240. Possible materials include a simple channel drilled in a block of aluminum. The length of the fluid transmission line 235 is any length consistent with making the appropriate connections to the transfer chamber 210 and the pressure sensor 240.

Using an incompressible fluid to transmit the pressure from a measurement chamber 215 to a remote pressure sensor 240 provides the following benefits. For example, the volume of the measurement chamber 215 can be minimized, and thereby substantially improve the response time of the resulting proximity sensor 200. A smaller volume is also commensurate with the increased density of topological mappings that in turn requires smaller exit apertures 270. Moreover, the architecture of the present invention is consistent with permitting the pressure sensor component to be at an arbitrarily remote location from the measuring chamber 215, without significant degradation to the overall response time performance.

As noted above, the use of an incompressible fluid enables the design engineer to remotely locate the pressure sensor 240. An incompressible fluid is however not totally incompressible. However, the term “incompressible” fluid is used in the sense that the fluid is a substantially incompressible fluid that does not appreciably change its volume when subjected to force from an external source (e.g., the deflection of the gas-fluid diaphragm 220). Examples of an incompressible fluid suitable for use with the present invention include but are not limited to water and oils.

A wide set of gases can be used in the present invention, subject to the requirement to be inert (and thereby not interact with the surface of the substrate 260 whose topology is undergoing scrutiny). Examples of a gas suitable for use with the present invention include but are not limited to air, nitrogen, hydrogen or any non-reactive compressible gas.

In alternative embodiments of the present invention, different implementations of the pressures sensor 240 are within the scope of the subject matter described herein. FIG. 2 illustrates a diaphragm-based pressure sensor, with a pressure sensor diaphragm 245 located in a pressure sensor measurement chamber 250. One side of the pressure sensor diaphragm 245 is exposed to the pressure transmitted by incompressible fluid in communication with the fluid transmission line 235. The chamber 255 on the other side of the pressure sensor diaphragm 245 permits movement of the pressure sensor diaphragm 245 in response to the pressure transmitted by the incompressible fluid in the fluid transmission line 235. Various approaches to the detection of the deflection of the pressure sensor diaphragm 245 are feasible, such as optical, capacitive, piezoresistive and inductive transducers. Other types of pressure sensors 240 that are capable of measurement of the pressure of an incompressible fluid coupled to a fluid transmission line 235 are within the scope of the present invention, e.g., a restricted mass flow meter. Representative commercial examples of such pressures sensors are a Honeywell AWM3300V.

In a further embodiment of the present invention, the measurement chamber 215 and the transfer chamber 210 may comprise various shapes. Although FIG. 2 suggests a cylindrical shape, embodiments of the present invention are not limited to this shape. Indeed, any shape that permits the location of the various parts described earlier is within the scope of the present invention. Specifically, the measurement chamber 215 can be any shape that enables the exit aperture 270, the input port 265, and the gas-fluid diaphragm 220 and their associated functions to be accommodated. Similarly, the transfer chamber 210 can be any shape that enables the gas-fluid diaphragm 220 and the coupling to the fluid transmission line 235 and their functions to be accommodated.

In a still further embodiment of the present invention, a bridge version of the fluid assisted gas gauge is within the spirit of the present invention. U.S. application Ser. Nos. 11/646,612 and 10/322,768, and U.S. Pat. Nos. 4,953,388 and 4,550,592, all of which are incorporated herein by reference in their entireties, disclose various aspects of exemplary bridge concepts. In a bridge version, two arms, a measurement arm and a reference arm, are used to provide a differential measurement. The measurement arm is constructed in a similar fashion to that described above, namely there is a measurement chamber whose pressure deflects a gas-fluid diaphragm which in turn applies pressure to a fluid transmission line that is coupled to a pressure sensor. The reference arm is also constructed in a similar fashion to the measurement arm, but has a reference standoff placed proximate to the exit aperture of the reference arm that results in a reference pressure being measured by a reference pressure sensor. Both the measurement arm and the reference arm are supplied with gas from the same gas source. However, in this embodiment, the difference in pressure readings found in the measurement and reference arms is used to determine the separation (and therefore the topography) of the surface of the substrate from the proximity sensor. This difference may be detected directly with a differential pressure sensor, or two independent pressure sensors whose measurements are differentiated by other means (i.e., electrically or with software) The bridge embodiment offers the advantage that any common mode errors (such as pressure variations within the gas source) are eliminated since they affect both sides of the bridge and are thereby cancelled in the differential measurement.

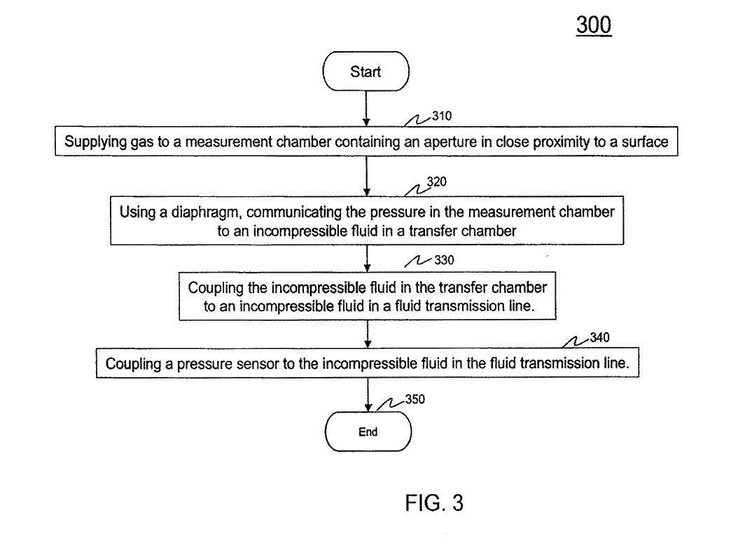

FIG. 3 provides a flowchart of a method 300 that uses an incompressible fluid subsystem to transmit the steady-state pressure originating in a measurement chamber across an arbitrary distance to a pressure sensor with rapid response time.

The process begins at step 310. In step 310, gas is supplied to a measurement chamber containing an aperture in close proximity to a surface.

In step 320, the pressure in the measurement chamber is communicated by a diaphragm to an incompressible fluid in the transfer chamber.

In step 330, the pressure in the incompressible fluid in the transfer chamber is communicated by the incompressible fluid in the fluid transmission line.

In step 340, the pressure sensor outputs a signal is response to the communicated pressure from the incompressible fluid in the fluid transmission line.

At step 350, method 300 ends.

### CONCLUSION

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. An apparatus, comprising:
a housing;
a measurement chamber within the housing, the measurement chamber including an exit aperture and a gas supply port wherein the gas supply port is configured to couple to a gas source to thereby supply a gas;
a transfer chamber within the housing, the transfer chamber containing an incompressible fluid;
a diaphragm disposed to form a gas-fluid interface between the measurement chamber and the transfer chamber, wherein the diaphragm is configured to deflect responsively to a pressure differential between the gas in the measurement chamber and the incompressible fluid in the transfer chamber;
a fluid transmission line containing incompressible fluid, wherein the incompressible fluid in the fluid transmission line is coupled to the incompressible fluid in the transfer chamber; and
a pressure sensor coupled to the fluid transmission line, wherein the pressure sensor is configured to output a signal responsive to a pressure of the incompressible fluid in the fluid transmission line.

2. The apparatus of claim 1, wherein the gas is one of air, nitrogen and hydrogen.

3. The apparatus of claim 1, wherein the gas is non-reactive compressible gas.

4. The apparatus of claim 1, wherein the measurement chamber is cylindrical.

5. The apparatus of claim 1, wherein the transfer chamber is cylindrical.

6. The apparatus of claim 1, wherein the pressure sensor includes a second diaphragm and a transducer, wherein the second diaphragm is configured to deflect in response to the pressure of the incompressible fluid in the fluid transmission line and the transducer is configured to output the signal in response to the deflection of the second diaphragm.

7. A method, comprising:
supplying a gas to a measurement chamber, wherein the measurement chamber includes an exit aperture that is separated by a distance from a surface such that a pressure in the measurement chamber is responsive to the distance;
communicating the pressure in the measurement chamber to an incompressible fluid in a transfer chamber by a diaphragm, wherein the diaphragm moves in response to a pressure differential between the measurement chamber and the transfer chamber;
communicating the pressure in the incompressible fluid in the transfer chamber to a pressure sensor by an incompressible fluid in a fluid transmission line; and
outputting a signal by the pressure sensor in response to the communicated pressure from the incompressible fluid in the fluid transmission line.

8. The method of claim 7, wherein the gas is one of air, nitrogen and hydrogen.

9. The method of claim 7, wherein the gas is a non-reactive compressible gas.

10. The method of claim 7, wherein the measurement chamber is cylindrical.

11. The method of claim 7, wherein the transfer chamber is cylindrical.

12. The method of claim 7, wherein the pressure sensor includes a second diaphragm and a transducer, wherein the second diaphragm is configured to deflect in response to the pressure of the incompressible fluid in the fluid transmission line and the transducer is configured to generate the signal in response to the deflection of the second diaphragm.

13. A lithographic system, comprising:
an illumination system configured to produce a beam of radiation;
a support device configured to support a patterning device that is capable of patterning the beam of radiation;
a projection system configured to project the patterned beam onto a substrate;
a housing;
a measurement chamber within the housing, the measurement chamber including an exit aperture proximate to the substrate and a gas supply port configured to couple to a gas source to thereby supply a gas;
a transfer chamber within the housing, the transfer chamber containing an incompressible fluid;
a diaphragm disposed to form a gas-fluid interface between the measurement chamber and the transfer chamber, wherein the diaphragm is configured to deflect responsively to a pressure differential between the measurement chamber and the transfer chamber;
a fluid transmission line containing incompressible fluid that is communicatively coupled to the incompressible fluid in the transfer chamber; and
a pressure sensor coupled to the fluid transmission line, wherein the pressure sensor is configured to output a signal responsive to a pressure of the incompressible fluid in the fluid transmission line.

14. The lithographic system of claim 13, wherein the gas is one of air, nitrogen and hydrogen.

15. The lithographic system of claim 13, wherein the gas is a non-reactive compressible gas.

16. The lithographic system of claim 13, wherein the measurement chamber is cylindrical.

17. The lithographic system of claim 13, wherein the transfer chamber is cylindrical.

18. The lithographic system of claim 13, wherein the pressure sensor includes a second diaphragm and a transducer, wherein the second diaphragm is configured to deflect in response to the pressure of the incompressible fluid in the fluid transmission line and the transducer is configured to output the signal in response to the deflection of the second diaphragm.

19. A fluid assisted gas gauge coupled to a pressure sensor for making proximity measurements with a high bandwidth, the fluid assisted gas gauge comprising:
a gas-filled measurement chamber coupled to a gas source for receiving a gas volume;
a fluid-filled transfer chamber containing an incompressible fluid; and
a diaphragm separating the gas-filled measurement chamber from the fluid-filled transfer chamber, wherein the fluid assisted gas gauge is configured to exhaust gas onto a surface being measured, while the incompressible fluid of fluid-filled transfer chamber transmits the pressure to the pressure sensor thereby minimizing the gas volume of the gas-filled measurement chamber such that a response time of making a proximity measurement is enhanced relative to the response time of a gas only gas gauge.

20. The fluid assisted gas gauge of claim 19, wherein the gas is one of air, nitrogen and hydrogen.
